(19) United States
(12) Patent Application Publication
(10) Pub. No.: US 2009/0157329 A1
(43) Pub. Date: Jun. 18, 2009

(54) Determining Solid Content Concentration in a Fluid Stream

(76) Inventors: Glenn Weightman, Duncan, OK (US); Bruce Lucas, Marlow, OK (US)

Correspondence Address: JOHN W. WUSTENBERG, P.O. BOX 1431, DUNCAN, OK, 73536, US

(21) Appl. No.: 11/957,071

(22) Filed: Dec. 14, 2007

(51) Int. Cl. G01N 31/00

(52) U.S. Cl. 702/25; 702/32

(57) ABSTRACT

A method for determining solid content concentration in a fluid flow includes measuring a noise signal generated by a fluid flow and correlating the noise signal to the solid content. The noise signal may be correlated to represent the solid content concentration such as by applying one or more filters to the noise signal or applying one or more physical or numerical methods to the noise signal. For example, the fluid flow may be pressurized to a selected level to collapse gas bubbled entrained in the fluid flow, thereby eliminating or substantially reducing a component of the noise signal unrelated to the solid content.

### TECHNICAL FIELD

This disclosure relates to determination of solid content of a fluid flow.

### BACKGROUND

Determining a solid content in a fluid flow is desirable in many industries, such as the energy services industry, paper manufacturing, mining, waste processing industries, as well as others. For example, hydraulic fracturing operations in the energy services industry may require knowledge of the amount or concentration of proppant, such as sand, in a fluid injected into a wellbore for the fracturing operation. Also, the concentration of solids, such as sand, contained in a fluid recovered from a wellbore may be desired. Similarly, in mining operations, measurement of concentrations of minerals or other solid components in mine slurries may be desired. For example, in coal mining, it may be desirable to know the concentration of coal in a coal slurry. In the paper manufacturing industry, the concentration of pulp in a slurry may be required or desired information.

Presently, solid concentration may be measured using a density measuring device, along with knowledge of the of the solid phase and the liquid phase of the fluid flow to infer the respective amounts each component in the fluid flow. Some densitometers require radioactive sources for density measurements. The radioactive sources have associated regulation, security, and disposal costs as well as liability for potential misuse.

### SUMMARY

The present disclosure relates to determining a solid content concentration in a fluid flow. One aspect encompasses a method for ascertaining the solid content in a fluid flow including receiving a signal from a flow meter measuring a fluid flow, the signal having a noise signal caused, at least in part, by solids in the fluid flow, and determining the solid content in the fluid flow based on the noise signal.

Another aspect encompasses an article of manufacture comprising a machine-readable medium storing instructions for causing one or more processors to perform operations including receiving data from a flow meter measuring a fluid flow, the signal having a noise signal caused, at least in part, by solids in the fluid flow and determining the solid content based on the noise signal.

A further aspect encompasses a method for controlling a solid content in a fluid flow including receiving a signal from a flow meter measuring a fluid flow, the signal having a noise signal caused, at least in part, by solids in the fluid flow, determining the solid content of the fluid flow utilizing the noise signal, and adjusting an amount of the solid added to the fluid flow based on the determined solid content.

The various aspects may include one or more of the following features. Determining the solid content based on the signal may include identifying a solid type contained in the fluid flow and correlating the noise signal with the solid type. Correlating the noise signal with the solid type may include associating a characteristic of the solid type with an aspect of the noise signal. Ascertaining the solid content in a fluid flow may also include diminishing a portion of the noise signal unrelated to solid content. Diminishing a portion of the noise signal unrelated to solid content may include pressurizing the fluid flow to collapse gas bubbles present therein. Diminishing a portion of the noise signal unrelated to solid content may include manipulating the noise signal with a filter. Diminishing a portion of the noise signal unrelated to solid content may include manipulating the noise signal with a numerical analysis. Ascertaining the solid content in a fluid flow may also include measuring a flow rate of the fluid flow. Measuring the flow rate of the fluid flow may include measuring the flow rate of an entirety of the fluid flow. Measuring the flow rate of the fluid flow may include measuring a side stream of the fluid flow. Ascertaining the solid content in a fluid flow may also include controlling the flow rate of the fluid flow through the side stream. Ascertaining the solid content in a fluid flow may also include adjusting an addition rate of the solid to the fluid flow based on the solid content determination. A flow meter for ascertaining the solid content of a fluid flow may be at least one of an acoustic flow meter or a magnetic flow meter.

The various aspects may also include one or more of the following features. The various aspects may include identifying a solid type contained in a fluid flow and correlating a noise signal with the solid type. A flow meter for outputting a signal containing a noise signal may be at least one of an acoustic flow meter or a magnetic flow meter.

The various aspects may further include one or more of the following features. Controlling the solid content in a fluid flow may include establishing a solid content setpoint, comparing the determined solid content with the solid content setpoint, and adjusting an amount of the solid added to the fluid flow based on the comparison. Establishing a fluid flow may include establishing a flow rate setpoint of the fluid flow, separating a portion of the fluid flow into a side stream, measuring the flow rate of the fluid flow in the side stream, comparing the measured flow rate with the flow rate setpoint, and adjusting the flow rate of the fluid flow based on the comparison. Controlling the solid content in a fluid flow may also include diminishing a portion of the noise signal unrelated to solid content. Diminishing a portion of the noise signal unrelated to solid content may include pressurizing the fluid flow to collapse gas bubbles present therein. Diminishing a portion of the noise signal unrelated to solid content may include manipulating the noise signal with a filter. Diminishing a portion of the noise signal unrelated to solid content may include manipulating the noise signal with a numerical analysis. At least one of an acoustic or a magnetic flow meter may be used to control in controlling the solid content in a fluid flow.

The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of a system utilizing a noise signal to determine a solid content concentration in a fluid flow;

FIG. 2 is a cross sectional view of a flow meter disposed in a conduit according to some implementations;

FIG. 3 is a graph illustrating a correlation between solid content of a fluid flow and a noise signal generated according to the present disclosure;

FIG. 4 is a block diagram of a system utilizing a noise signal for closed loop control of the solid content in a fluid flow; and

FIG. 5 is a method for controlling the solid content in a fluid flow.

### DETAILED DESCRIPTION

Determination of solid content (solid phase) of a fluid flow, as provided herein, is described with reference to a hydraulic fracturing operation (referred to interchangeably as “fracturing operation”) used, for example, to enhance production of a production fluid from a wellbore. However, the present disclosure is not so limited and is applicable to all or substantially all applications requiring determination of a solid concentration in a fluid flow.

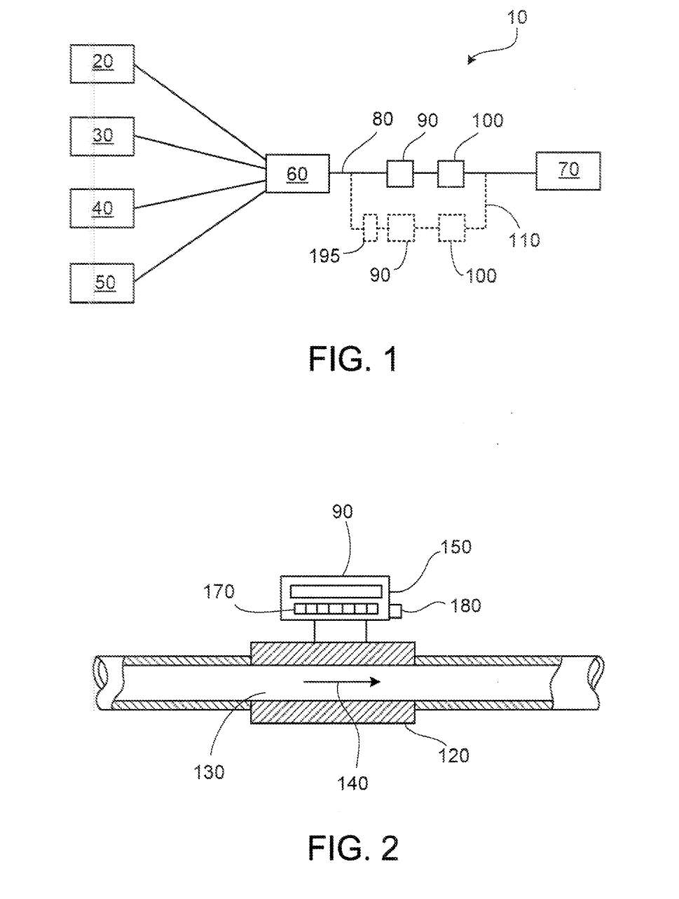

FIG. 1 shows a block diagram of a system 10 for performing a fracturing operation. The system 10 includes a proppant 20, such as sand, a dry gel particulate (“gel”) 30, a base liquid 40, such as water, and other additives 50, as desired. The different components are fed to and combined with a blender apparatus 60 to form a fracturing fluid. The fracturing fluid is injected into a wellbore 70 to create a fracture network at one or more locations in the earth to enhance production of a production fluid through the wellbore 70.

When performing the fracturing operation, the amount of proppant 20 contained in the fracturing fluid may be controlled, for example, to control the fracturing of the wellbore 70. Thus, the fracturing fluid may be transported from the blender apparatus 60 to the wellbore 70 through a conduit 80, for example, to measure an entirety of the fluid flow. According to one implementation, a flow meter 90 may be disposed at a location along the conduit 80. The flow meter 90 is operable to determine both the total flow rate and the solid content of the fracturing fluid. For example, in one operating mode, the flow meter 90 may be insensitive to solids in the flow and, therefore, operable to determine the total volumetric flow rate. In another operating mode, the flow meter 90 may be sensitive to the solid content in the fluid flow and, therefore, operable to determine the solid content within the fluid flow. According to some implementations, the flow meter 90 may detect solid content within the fluid flow by generating a voltage noise signal or an acoustic noise signal, for example. With knowledge of the solid content and the total flow rate of the fracturing fluid, the liquid component of the fracturing fluid may also be determined.

In some implementations, the noise signal may be generated as the solid content of the fluid flow passes through a magnetic field, such as a magnetic field generated by the flow meter. At a high magnetic field strength, the noise signal caused by the solid content may be low and, thus, “drowned out.” At a low magnetic field strength, the noise signal may be high, providing a sensitivity to the solid content. Consequently, the flow meter, such as flow meter 90, may be operated with a high strength magnetic field to measure the total fluid flow rate and at a low strength magnetic field to detect the solid content concentration.

According to another implementation, a second flow meter 100 may be disposed in the conduit 80. The flow meters 90 and 100 determine one of the total flow of the fracturing fluid and the solid content of the fracturing fluid. For example, the flow meter 90 may be operable to determine the total flow rate of the fracturing fluid, while the flow meter 100 may be operable to determine the solid content of the fracturing fluid. Alternatively, the flow meter 100 determines the total flow rate, and the flow meter 90 determines the solid content. Further, the flow meter 90, when utilized to determine both the total flow rate and solid content of the fracturing fluid, or both flow meters 90 and 100, when used in combination, may be utilized to measure a side stream 110 of the fracturing fluid that may be representative of the entire fracturing fluid flow. The flow rate of the fracturing fluid through the side stream 110 may be controlled based on, for example, the Reynolds number of the fluid, to eliminate some causes of noise unrelated to the solid content. Alternately or in combination, noise at one or more frequencies may be isolated as an indication of the solid content. These frequencies may be different depending upon the properties of the solid forming the solid phase, such as size, shape, chemical composition, etc. The measurements provided by one or more of the flow meters 90 and 100 in the side stream 110 may be scaled accordingly to determine the solid content (and liquid content, if desired) of the entire fracturing fluid flow.

FIG. 2 shows a detail view of a flow meter, such as flow meter 90 and/or flow meter 100. The description of a flow meter within the scope of the present disclosure is provided with reference to flow meter 90. However, it is understood that the description is also applicable to the flow meter 100, and flow meter 90 is used merely as an example. The flow meter 90 includes a housing 120 that defines a cavity 130 through which a fluid (indicated by arrow 140), such as the fracturing fluid, flows. The flow meter 90, 100 also includes a control module 150. The control module 150 may include one or more processors that execute instructions and manipulates data to perform operations and may be, for example, a central processing unit (CPU), a blade, an application specific integrated circuit (ASIC), or a field-programmable gate array (FPGA). Processors suitable for the execution of a computer program include, by way of example, both general and special purpose microprocessors, and any one or more processors of any kind of digital computer. Generally, the processor will receive instructions and data from ROM or RAM or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The control module 150 may also include one or more memory devices. Each memory device may include any memory or database module and may take the form of volatile or non-volatile memory including, without limitation, magnetic media, optical media, random access memory (RAM), read-only memory (ROM), removable media, or any other suitable local or remote memory component. The one or more memory devices may include application data for one or more applications, as well as data involving VPN applications or services, firewall policies, a security or access log, print or other reporting files, HTML files or templates, related or unrelated software applications or sub-systems, and others. Consequently, the memory may also be considered a repository of data, such as a local data repository for one or more applications.

The control module 150 may also include an output device, such as a display device 160, e.g., a cathode ray tube (“CRT”) or LCD (liquid crystal display) monitor, for displaying information to the user, as well as an input device 170, such as a keyboard, keypad, and/or a pointing device, e.g., a mouse or a trackball, by which the user can provide input to the computer. Other kinds of devices can be used to provide for interaction with a user as well to provide the user with feedback. For example, feedback provided to the user can be any form of sensory feedback, e.g., visual feedback, auditory feedback, or tactile feedback; and input from the user can be received in any form, including acoustic, speech, or tactile input. The flow meter 90 may also include an input/output port 180 for inputting and/or outputting data from the flow meter 90.

The application may be any application, program, module, process, or other software that may utilize, change, delete, generate, or is otherwise associated with the data and/or information associated with one or more control operations of the flow meter 90. “Software” may include software, firmware, wired or programmed hardware, or any combination thereof as appropriate. Indeed, the application may be written or described in any appropriate computer language including C, C++, Java, Visual Basic, assembler, Perl, any suitable version of 4GL, as well as others. It will be understood that, while the application may include numerous sub-modules, the application may instead be a single multi-tasked module that implements the various features and functionality through various objects, methods, or other processes. Further, while the application may be internal to control module 150, one or more processes associated with the application may be stored, referenced, or executed remotely (e.g., via a wired or wireless connection, such as via the input/output port 180). For example, a portion of the application may be a web service that is remotely called, while another portion of the application may be an interface object bundled for processing at remote client. Moreover, the application may be a child or sub-module of another software module or application. Indeed, the application may be a hosted solution that allows multiple parties in different portions of the process to perform the respective processing.

The flow meter 90 may be an electromagnetic flow meter (“magnetic flow meter”), an acoustic flow meter (e.g., transit time ultrasonic flow meters and Doppler ultrasonic flow meters), or other flow meters capable of producing a noise signal related to solid content in the fluid flow. In an application using a magnetic flow meter, solid content particles can cause interference in a generated magnetic field, producing a noise signal. The more particles, the larger the noise signal, providing an indication of the solid content concentration. In the case of a Doppler effect ultrasonic flow meter, sound waves are reflected off of solid particles present in the fluid flow, providing an indication of solid content concentration. Because operation of both magnetic and acoustic flow meters is known in the art, further description of their operation is omitted.

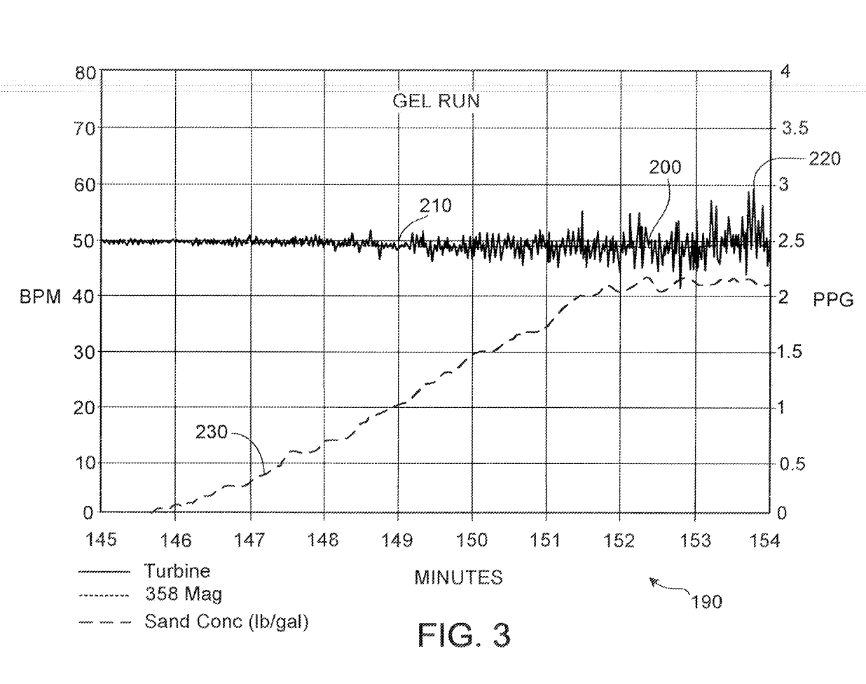

In operation, as the fracturing fluid passes through the cavity 130 of the flow meter 90, the solid content generates a noise signal, as shown in FIG. 3. FIG. 3 is a chart 190 indicating a changing solid content in a fluid flow. Chart 190 includes graphs 200 and 210 each indicating a flow rate measurement at approximately 50 barrels per minute (BPM). The chart 190 also includes a solid concentration graph 230 indicating a solid concentration in the fluid flow. The graph 200 has a noise component or signal 220 correlated to the solid content of the fluid flow. As the solid content increases, the noise signal 220 correspondingly increases. Thus, as the sand content in the fracturing fluid increases, the corresponding noise signal also increases.

According to some implementations, the noise signal may be quantified using a variety of methods associated with AC signals. For example the RMS amplitude of the noise signal 220 may be determined and used as an indication of the solid content concentration. The solid content and noise signal may be correlated so that an output of the flow meter is able to directly indicate the solid concentration. For example, the noise signal may be related to solid concentration through an empirically determined mathematical relationship. Also, the noise signal data may be manipulated, such as with a filter (e.g., one or more physical and/or mathematical filters) or one or more methods (e.g., one or more physical and/or numerical methods, such as signal processing) to represent solid content within the fluid flow. Consequently, according to some implementations, one or more frequencies of the noise signal corresponding to one or more solids of a defined particle size may be isolated, permitting measurement of the solid content on a particle size basis. Alternately, the noise signal may be output of the flow meters 90, such as from the input/output port 180 to a computing device or controller (not shown) for determining the solid content apart from the flow meter 90 or at a remote location. The information transmitted by flow meter 90 may be transmitted over a wire or wireless connection.

The noise generated by the solid content within a fluid flow may depend on the size, shape, and concentration of the solid as well as the solid type. Additionally, noise may be at least partially the result of the flow rate, e.g., the average flow rate, of the fluid and the fluid's viscosity. Other factors, such as any entrained gases may affect the noise signal where the gas forms bubbles at a detectable size. To eliminate or substantially reduce some factors affecting the noise signal, a side stream of the fluid flow may be measured, as described above. Referring again to FIG. 1, the side stream 110 may be maintained in a conduit having a flow control device 195, such as a pump, to maintain a desired flow rate through the side stream 110. By maintaining a selected flow rate through the side stream 110, some variables affecting noise may be eliminated or substantially reduced, such as, noise that may be the result of viscosity and flow rate. For example, some fluids may behave as non-Newtonian fluids, i.e., the fluid's viscosity is a function of the fluid's shear rate. Thus, by changing the shear rate of the fluid, the noise caused by viscosity may be reduced. By reducing or eliminating sources of noise, the resulting noise signal are largely caused by the solid content of the fluid.

Entrained gases in a flow may also be a source of noise in a fluid flow. Consequently, the flow meter 90 may also be utilized to measure a gas concentration in the flow, depending upon the size of the gas bubbles in the flow. For example, determining gas content within a fluid flow may be important when performing a nitrogen foam fracturing operation. In such an operation, the content of nitrogen gas (N₂) within the fluid affects the quantity and quality of the foam produced. Consequently, accurate measurement of the N₂ in the fluid is desirable.

However, noise due to gas entrained in the flow may not be desirable, such as when determination of only the solid content is desired. Gas entrained in a fluid flow may be introduced, for example, when a solid is added to a fluid to form a slurry or when a solid is added to an existing slurry. To eliminate or substantially reduce noise caused by entrained gases, the fluid pressure may be increased. For example, increasing fluid pressure to approximately 50 to 200 psi can cause gas bubbles to collapse, effectively eliminating noise associated with the gas.

As described above, noise associated with solid content may be related to the size, shape, and concentration of the solid in the fluid. By correlating the size and shape of a particular solid, such as sand, with the noise associated therewith, this noise may be filtered or otherwise reduced so that the resulting noise is due primarily to the concentration of the solid in the fluid flow. For example, different sand types may have associated therewith particular shapes and sizes. The noise associated with the different types of sand may be determined and stored, such as in memory of the control module 150. Thus, for a fracturing operation, an operator may input or otherwise select the type of proppant added to the fracturing fluid. During the fracturing operation, the control module 150 may use the stored information to filter out the noise associated with the size and shape of the sand, leaving the remaining noise primarily the result of solid concentration (assuming other noise factors have similarly been eliminated or substantially reduced). Consequently, solid content may be accurately monitored.

Some solids also include other properties that produce or contribute to a noise signal. Thus, such properties may also be used to measure the concentration of the solid in the fluid. For example, some sands are piezoelectric materials. Thus, some sands generate a voltage when a pressure is applied. This voltage is a source of noise that may be detected to determine solid content.

Where a single flow meter is utilized to determine both total flow rate and solid content, the flow meter may apply signal processing techniques, changes in magnetic field strength and/or direction (e.g., in the case of a magnetic flow meter), or changes in sound amplitude or frequency (e.g., in the case of an acoustic flow meter) to eliminate the noise component, e.g., noise caused by the solid content. Thus, when these techniques are applied, the flow meters are able to eliminate or reduce the noise caused by the solid content and determine the total flow. To determine the solid content concentration, the signal processing may be disabled, allowing the generation of the noise signal and, thus, permitting the determination of the solid content.

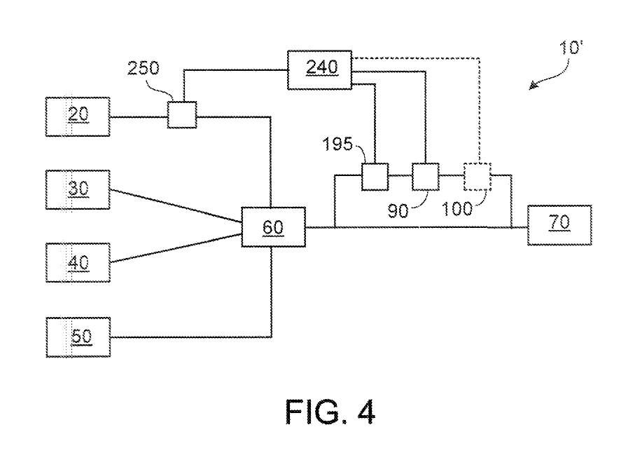

Use of a flow meter according to the present disclosure provides for closed loop control of solid content within a fluid flow. FIG. 4 illustrates a system 10′, similar to the system 10 described above with reference to FIG. 1. The system 10′ includes a controller 240 coupled to a control mechanism 250, such as a precision auger, conveyor, valve, or pump, for controlling an amount of the proppant 20 added to the fluid flow. The controller 240 may also be coupled to the control device 195 and the flow meter 90. In the case two flow meters 90, 100 are used, e.g., one for measuring total fluid flow and the other for measuring solid content, the controller 240 may be coupled to the flow meters 90, 100. Further, the controller 240 may also be coupled to one or more flow control or monitoring devices (not shown) for controlling and/or monitoring other aspects of the fracturing operation, such as controlling and/or monitoring addition of the dry gel 30, the base liquid 40, and other additives 50. Also, although the system 10′ is shown as measuring the fracturing fluid via the side stream 110, the side stream 110 may be eliminated, and the entire fracturing fluid flow may be measured directly. For simplicity, the system 10′ will be described as using a single flow meter, e.g., flow meter 90, for determining both total fluid flow and the solid content within the fluid flow, as described above. However, it will be understood that other flow meters, such as flow meter 100, may also be used in combination, wherein one flow meter is used to determine solid content and the other flow meter is used to determine a total flow rate of the fluid flow (i.e., a total flow of both the solid and liquid phases).

In operation of the system 10′, a solid content setpoint of the fracturing fluid is selected. As the fracturing fluid flows between the blender apparatus 60 and the wellbore 70, the solid content is measured by the flow meter 90, for example, as explained above. According to some implementations, this solid content is displayed to a user, who compares the measured solid content to the solid content setpoint and manually alters the solid content accordingly, such as by manipulating a control of the control mechanism 250. For example, when the measured solid content is less than the solid content setpoint, the user may increase an amount of proppant 20 added to the blender. According to other implementations, the system is controlled automatically by the controller 240. Thus, when the measured solid content and the solid content setpoint do not correspond, the controller 240 transmits a control signal to the control mechanism 250 to adjust the amount of proppant 20 added to the blender apparatus 60 accordingly. The distance of the flow meter for measuring the solid content may be located at a position close to the outlet of the blender apparatus 60 to react quickly to changes in the solid content concentration.

When using the slip stream 110 to measure the solid content of the fracturing fluid, the controller 240 may receive flow rate signals from the flow meter 90. The total flow rate data, along with other information related to the fracturing fluid, such as properties of the gel 30, proppant 20, base liquid 40, the other additives 50, piping geometry and/or dimensions, and other information, may be used by the controller 240 to establish and/or control a flow rate of the fracturing fluid through the side stream 110 via the control device 195. The controller 240 may also establish the flow rate of the fracturing fluid based on a user-selected flow rate. Controlling the flow rate of the fracturing fluid through the side stream 110 may reduce noise detected by the flow meter unrelated to the solid content of the fracturing fluid. Consequently, the controller 240 may transmit control signals to the control device 195 to maintain a flow rate of the fracturing fluid, such as a flow rate at a selected Reynolds number. As described above, controlling the flow rate of the fracturing fluid through the side stream 110 may reduce causes of signal noise so that a more accurate determination of solid content may be made.

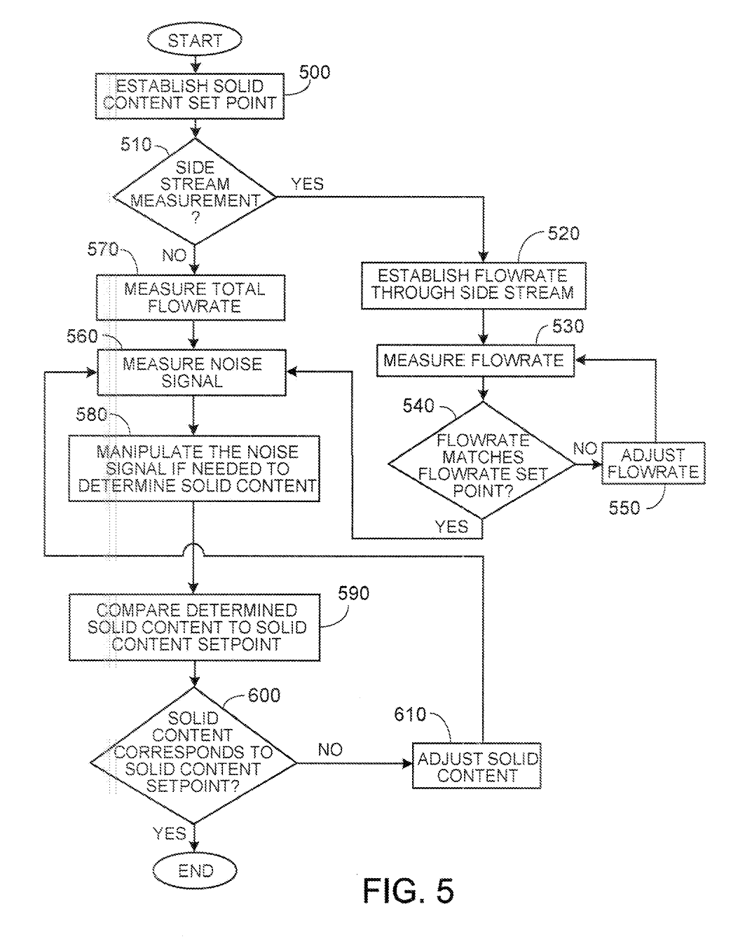

FIG. 5 is an example flowchart for controlling a solid content concentration of a fluid flow. At 500, a desired solid content concentration is established with a setpoint. At 510, a determination is made as to whether the entire fluid flow is measured or a slip stream of the fluid flow is measured. If a slip stream is measured, a flow rate through the slip stream is defined at 520. As explained above, the flow rate may be established at a selected shear rate or Reynolds number, for example, to eliminate noise causing variables that are unrelated to solid content. The flow rate of the fluid flow is measured at 530 and a determination is made at 540 as to whether the measured flow rate corresponds to the flow rate setpoint. If the flow rate does not correspond, the flow rate is adjusted at 550, such as by adjusting a flow control device, e.g., a pump, and the flow rate is remeasured at 530. If the flow rate does correspond, the noise signal is measured at 560. If a slip stream is not used, the flow rate is measured at 570 and the noise signal is measured at 560.

Once the noise signal is measured, the noise signal may be manipulated at 580, such as by applying filters or numerical methods, e.g., determining the RMS amplitude of the noise signal, to determine the solid content concentration of the fluid flow. The measured solid content concentration is compared to the solid content concentration setpoint at 590, and, at 600, a determination is made as to whether the measured solid content concentration corresponds to the solid concentration setpoint. If the measurement and the setpoint match, the “yes” route is followed in which case the process may be repeated for a selected time period, for a duration of an operation, until a condition is satisfied or not satisfied, or the process may terminate. If the measured and setpoint values do not correspond, the solid content is increased or decreasing accordingly at 610, such as by increasing or decreasing a rate of addition of the solid. The noise signal is then remeasured at 560 and then steps 580-600 are repeated.

Flow meters incorporating the capability described herein eliminate some problems associated with radiological densitometers, such elimination of regulatory compliance, security, and disposal costs as well as elimination of potential misuse associated with the radioactive elements present in such densitometers. Further, flow meters capable of generating a noise signal corresponding to solid content concentration are capable of measuring solid content of fluid flows in which the solid material has a density similar to the density of the carrier fluid.

A number of implementations have been described. Nevertheless, it will be understood that various modifications may be made without departing from the spirit and scope of the disclosure. Accordingly, other implementations are within the scope of the following claims.

What is claimed is:

1. A method for ascertaining a solid content in a fluid flow comprising:
receiving a signal from a flow meter measuring a fluid flow, the signal having a noise signal caused, at least in part, by solids in the fluid flow; and
determining the solid content in the fluid flow based on the noise signal.

2. The method according to claim 1, wherein determining the solid content based on the signal comprises:
identifying a solid type contained in the fluid flow; and
correlating the noise signal with the solid type.

3. The method according to claim 1, wherein correlating the noise signal with the solid type comprises associating a characteristic of the solid type with an aspect of the noise signal.

4. The method according to claim 1 further comprising diminishing a portion of the noise signal unrelated to solid content.

5. The method according to claim 4, wherein diminishing a portion of the noise signal unrelated to solid content comprises pressurizing the fluid flow to collapse gas bubbles present therein.

6. The method according to claim 4, wherein diminishing a portion of the noise signal unrelated to solid content comprises manipulating the noise signal with a filter.

7. The method according to claim 4, wherein diminishing a portion of the noise signal unrelated to solid content comprises manipulating the noise signal with a numerical analysis.

8. The method according to claim 1 further comprising measuring a flow rate of the fluid flow.

9. The method according to claim 8, wherein measuring the flow rate of the fluid flow comprises measuring the flow rate of an entirety of the fluid flow.

10. The method according to claim 8, wherein measuring the flow rate of the fluid flow comprises measuring a side stream of the fluid flow.

11. The method according to claim 10 further comprising controlling the flow rate of the fluid flow through the side stream.

12. The method according to claim 1 further comprising adjusting an addition rate of the solid to the fluid flow based on the solid content determination.

13. The method according to claim 1 wherein the flow meter is at least one of an acoustic flow meter or a magnetic flow meter.

14. An article of manufacture comprising a machine-readable medium storing instructions for causing one or more processors to perform operations comprising:
receiving data from a flow meter measuring a fluid flow, the signal having a noise signal caused, at least in part, by solids in the fluid flow; and
determining the solid content based on the noise signal.

15. The article according to claim 14 wherein the instructions adapted to cause the one or more processors to perform the operation of determining the solid content based on the signal comprise instructions adapted to cause the processor to perform operations comprising:
identifying a solid type contained in the fluid flow; and
correlating the noise signal with the solid type.

16. The article according to claim 14 wherein the flow meter is at least one of an acoustic flow meter or a magnetic flow meter.

17. A method for controlling a solid content in a fluid flow comprising:
receiving a signal from a flow meter measuring a fluid flow, the signal having a noise signal caused, at least in part, by solids in the fluid flow;
determining the solid content of the fluid flow utilizing the noise signal; and
adjusting an amount of the solid added to the fluid flow based on the determined solid content.

18. The method according to claim 17 further comprising:
establishing a solid content setpoint;
comparing the determined solid content with the solid content setpoint; and
adjusting an amount of the solid added to the fluid flow based on the comparison.

19. The method according to claim 17 wherein establishing a fluid flow comprises:
establishing a flow rate setpoint of the fluid flow;
separating a portion of the fluid flow into a side stream;
measuring the flow rate of the fluid flow in the side stream;
compare the measured flow rate with the flow rate setpoint; and
adjust the flow rate of the fluid flow based on the comparison.

20. The method according to claim 17 further comprising diminishing a portion of the noise signal unrelated to solid content.

21. The method according to claim 20, wherein diminishing a portion of the noise signal unrelated to solid content comprises pressurizing the fluid flow to collapse gas bubbles present therein.

22. The method according to claim 20, wherein diminishing a portion of the noise signal unrelated to solid content comprises manipulating the noise signal with a filter.

23. The method according to claim 20, wherein diminishing a portion of the noise signal unrelated to solid content comprises manipulating the noise signal with a numerical analysis.

24. The method according to claim 17 wherein the flow meter is at least one of an acoustic or a magnetic flow meter.
